(19) United States
(12) Patent Application Publication
(10) Pub. No.: US 2002/0115949 A1
(43) Pub. Date: Aug. 22, 2002

(54) Pressure device and system for preventing thrombosis

(76) Inventors: Stephen D. Kuslich, Stillwater, MN (US); Francis Peterson, Prescott, WI (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/050,799

(22) Filed: Jan. 16, 2002

Related U.S. Application Data
(60) Provisional application No. 60/262,048, filed on Jan. 16, 2001.

(51) Int. Cl. A61H 7/00; A61H 19/00

(52) U.S. Cl. 601/152; 601/11

(57) ABSTRACT

A system for providing prophylaxis against thrombosis comprises in combination a vehicle and a plurality of inflatable compression sleeves. The vehicle has a pneumatic pressure source for supplying a predetermined flow of pneumatic fluid to a plurality of passenger positions. The pneumatic pressure source has a plurality of leads, which extend to a connection port located in each of the passenger positions. Each of the inflatable compression sleeves has a plurality of inflatable chambers therein. The sleeves are constructed to be engaged to a connection port, thereby providing fluid communication between the pneumatic pressure source and the plurality of chambers. The sleeves may be worn by a passenger to help prevent the occurrence of deep vein thrombosis. Individual sleeves comprise at least two inflatable chambers wherein a second inflatable chamber is subsequent to the inflation of a first inflatable chamber.

### CROSS-REFERENCE TO RELATED APPLICATIONS

This application claims priority from U.S. provisional application No. 60/262,048, filed Jan. 16, 2001, the entire content of which is incorporated herein by reference.

### STATEMENT REGARDING FEDERALLY SPONSORED RESEARCH

Not Applicable

### BACKGROUND OF THE INVENTION

1. Field of the Invention

The present invention is directed to several embodiments. In at least one embodiment the invention is directed to an apparatus for improving the vascular blood flow in the extremities of individuals who are positioned in a confined manner, such as for example those traveling for long distances in an airplane or other vehicle. In at least one embodiment, the invention is directed to a system having at least one rhythmically inflatable cuff, sleeve, collar or other member that may be fitted around one or more limbs, particularly the leg or legs, of one or more individuals that is pneumatically activated encouraging blood flow and preventing deep vein thrombosis from occurring in the limb or limbs of any individual wearing the rhythmically inflatable member. In such an embodiment any and all rhythmically inflatable members may be in fluid communication with a centralized inflation source. Such a centralized inflation source may be provided to a vehicle, such as a car, bus, train, airplane, etc., to provide passengers therein with access the rhythmically inflatable members.

2. Description of the Related Art

It has long been suspected that a link exists between extended airplane flights and the formation of blood clots in a persons legs. This so-called “economy class syndrome” has been blamed for a number of blood clots and other maladies which affected people who were know to have recently traveled over a long distance in the cramped conditions of an airplane.

As a result, recent studies have been conducted which have shown that there does appear to be a link between extended periods of immobility in confined quarters, such as a person might experience on a long journey in an airplane or other vehicle, and the occurrence of Deep Vein Thrombosis (DVT) or the formation of blood clots in the lower extremities of an individual.

While several factors, such as advanced age, a persons weight, and other health characteristics may increase or decrease the likelihood of DVT occurring, extended periods of immobility, are a likely cause of DVT occurring in the legs. If a person does suffer from DVT, a potentially fatal blood clot could form which may be large enough that the clot does not naturally dissolve. Such a clot may break loose and travel from the person's leg to their heart or lungs resulting in serious illness or even death.

While numerous treatment and preventative strategies exist, the most common way of avoiding the occurrence of DVT is to exercise the legs by flexing the leg muscles or simply getting up and briefly walking around perhaps once an hour or more if possible. The action of walking stimulates blood flow by causing contracting muscles to pump the blood onward through the legs. Unfortunately, under many circumstances a persons mobility may be limited to such an extent that walking around is not possible or is undesirable. For example, as airlines attempt to force more and more seats onto a plane, not only are the seats more cramped but the isles are reduced in size, thus reducing the ability of a passenger to move about. In addition to airline travel there may be a link between DVT and other conditions where people required or chose to sit for long periods of time such as when driving, working at a desk or assembly line, watching television in their home, etc.

Because people are often restricted in their mobility or simply choose to not get up and walk around in an advisable manner, several devices have been developed to provide people with a means of stimulating blood flow through their limbs, notably the legs, and thus prevent DVT from occurring.

One device is a compression stocking or sock available from BeiersdorfJobst, Inc. of Charlotte, N.C. Compression stockings are effective at preventing leg swelling by providing a custom fit stocking that provides supportive pressure distribution to the legs. Unfortunately, compression stockings do not provide a flexing or pumping action to the legs to actively stimulate blood flow as is desired.

A more desirable approach is taken by several medical devices which provide a pumping action to the leg or legs by sequential pressurization of an inflatable collar or sleeve which may be fitted over an individual's limbs.

U.S. Pat. No. 4,013,069 to Hasty, describes an elongate pressure sleeve having a plurality of separate inflatable chambers. The sleeve is enclosed about a patients' limb and a pressure source provides a plurality of pressure pulses to the chambers in a timed sequence to provide a compression pressure gradient to the limb.

A similar device is described in U.S. Pat. No. 4,029,087 to Dye et al., which describes an elongate sleeve having a plurality of inflatable chambers which may be gradually inflated from an inflation source to provide a greater pressure in each inflated lower chamber than the pressure in any upper inflated chamber.

U.S. Pat. No. 6,007,559 to Arkans describes an apparatus having a plurality of inflatable chambers wherein at least two of the chambers are separated from each other to allow observation of the limb exposed therebetween.

The entire content of each of the above cited patents being incorporated herein by reference in their entirety.

Of the various chambered sleeve devices described above, none of the devices described appear to be suitable for use en mass by passengers on an airplane. The devices, their control systems and the equipment required to inflate the devices would be prohibitively bulky, heavy, and potentially dangerous in the controlled environment of an aircraft. An additional problem with current devices is the need to include an electronic power supply which could interfere with the radio frequency used by the aircraft of an aircraft resulting in potentially fatal consequences for those on board.

Presently there does not exist an anti-thrombosis device which is suitable for use for individuals traveling on vehicles, such as airplanes. Such a device would need to be light weight, especially if the device were to be provided to each passenger on a commercial airliner; potentially several hundred devices. In order to further reduce the devices weight the device should be capable of being adapted for connection to a central pressure supply of the aircraft in order to avoid the use of an individual inflation apparatus for each device. The device must be easy to apply and be used, such that virtually anyone could utilize the device safely and effectively with little or no assistance and/or instruction.

### BRIEF SUMMARY OF THE INVENTION

As indicated above the present invention may be embodied in a variety of forms. In at least one embodiment, the invention provides for an anti-thrombosis device which addresses the need to provide individuals with a light weight low complexity anti-thrombosis device capable of being used on a vehicle, such as an airplane, in a safe and effective manner.

Currently most commercial aircraft have an internal pneumatic air source. Each passenger position or seat may have one or more access ports and associated controls which allows the passenger to access the air source to provide an individual with a directed flow of warmed or cooled air as desired. In addition, some aircraft have employed a pneumatic system for providing each seat with audio output, which may be accessed by headphones.

Some embodiments of the invention may be configured to employ the existing internal pneumatic air source of an aircraft, to inflate a collar, cuff, sleeve or other inflatable member, hereinafter collectively referred to as a sleeve, which may be worn over a limb, such as a leg, or portion thereof, of a passenger. Alternatively, one or more sleeves may be provided with a separate pneumatic source.

In an airplane, the pneumatic air source supplies air to each seat of the airplane to supply an individual anti-thrombosis sleeve with sufficient pneumatic pressure to inflate the sleeve in a manner desired. The sleeve may employ one or more valves which allow pressure to be sequentially directed through the sleeve and then released. The pneumatic pressure may be controlled such that the sleeve is inflated and deflated in a continuous and repeating pattern or cycle, i.e. rhythmic inflation and deflation.

In at least one embodiment of the invention, the invention is directed to a portable sleeve which is sized to be fitted around the limb or limbs of an individual. The sleeve has a plurality of inflatable chambers which may be sequentially inflated to provide an advancing pressure or “milking” action from one end of a limb to another. For example, the chambers may be rhythmically inflated to apply pressure that advances from a lower portion of the limb to the upper portion of the limb. In at least one embodiment of the invention the sleeve or sleeves are portable and have at least one connection member in fluid communication with the inflatable chambers and which is adapted to be connected to a pneumatic air source. The pneumatic air source may be a centralized source with sufficient pressure to inflate one to a plurality of sleeves. Alternatively, the pneumatic air source may be configured to supply pneumatic pressure to only one or only a few sleeves and which may be readily portable by the wearer of a sleeve or sleeves.

In at least one embodiment of the invention, the portable sleeve is constructed of lightweight plastic.

In at least one embodiment of the invention, the portable sleeve is disposable.

In at least one embodiment of the invention, the sleeve is an adjustable cuff which may be adjusted to accommodate a variety of limb sizes.

In at least one embodiment of the invention the sleeve employs a plurality of pressure control valves, wherein the pressure control valves are in fluid communication with adjacent chambers, whereby when a first chamber is inflated to a predetermined pressure, the pressure valve opens to transmit the pressure of the first chamber to a second adjacent chamber.

In at least one embodiment of the invention the sleeve includes a plurality of pressure relief valves, the pressure relief valves providing the chambers of the sleeve with the capacity to accumulate and release pressure according to a predetermined cycle.

In at least one embodiment of the invention, the sleeve has at least one control valve, the at least one control valve providing an individual with the ability to control the pressure of the sleeve as may be desired.

In at least one embodiment of the invention, the pneumatic air source has a plurality of pressure supplying leads. Each of the pressure supplying leads providing a flow of pneumatic pressure sufficient to inflate a sleeve in a manner desired.

In at least one embodiment of the invention, each of the pressure supplying leads having a shut-off valve.

In at least one embodiment of the invention, the pneumatic air source having a central control device. The central control device being adapted to provide the plurality of pressure supplying leads with a predetermined flow of pressure, such that a sleeve associated with the pressure supplying lead is inflated and deflated according to the predetermined flow of pressure.

### BRIEF DESCRIPTION OF THE SEVERAL VIEWS OF THE DRAWINGS

a detailed description of the invention is hereafter described with specific reference being made to the drawings.

FIG. 1 is a side view of an embodiment of an inflatable sleeve which may be utilized in at least one embodiment of the inventive system.

FIG. 2 is a side view of an embodiment of the invention wherein the inventive system is utilized on an airplane.

FIG. 3 is a schematic depiction of an embodiment of a controller utilized in at least one embodiment of the inventive system.

FIG. 4 is a frontal view of an embodiment of an inflatable sleeve which is a cuff that may be utilized in at least one embodiment of the inventive system.

FIG. 5 is a close-up side view of an embodiment of an inflation member and plug utilized with the inflatable sleeve depicted in FIG. 4.

FIG. 6 is a frontal view of an embodiment of an embodiment of the invention wherein inflatable sleeve is a cuff.

FIG. 7 is a schematic view of a valve assembly configuration which may be utilized in an embodiment of the present invention.

FIG. 8 is a schematic view of a valve assembly configuration which may be utilized in an embodiment of the present invention.

FIG. 9 is a schematic view of a valve assembly configuration which may be utilized in an embodiment of the present invention.

FIG. 10 is an environmental view showing an embodiment of the invention wherein the pneumatic source is portable.

### DETAILED DESCRIPTION OF THE INVENTION

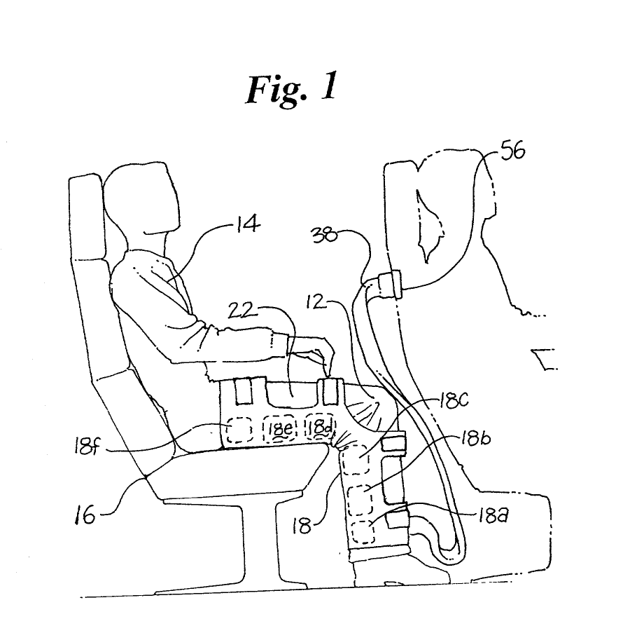

As may be seen in FIG. 1, the present invention is directed to an anti-thrombosis collar or sleeve 10 which may be worn about the extremities or legs 12 of an individual 14 when the individual 14 is positioned in a confined manner such as when sitting in a seat 16 for an extended period of time.

The sleeve 10 may have a wide range of configurations for directing blood flow through pneumatic action. The sleeve 10, employs a plurality of chambers 18 which may be sequentially inflated starting at the ankle 20 and ending in the upper thigh 22 to provide a “milking” action which helps to stimulate venous blood flow upward through the leg(s) 12. Once the chambers 18 are all pressurized, the air pressure may be released to deflate all of the chambers 18 to a predetermined ambient pressure. The chambers may then be once again reinflated from the ankle 20 to the thigh 22 to repeat the inflation cycle. If desired, the sleeve 10 may be inverted to provide rhythmic inflation in the opposite direction.

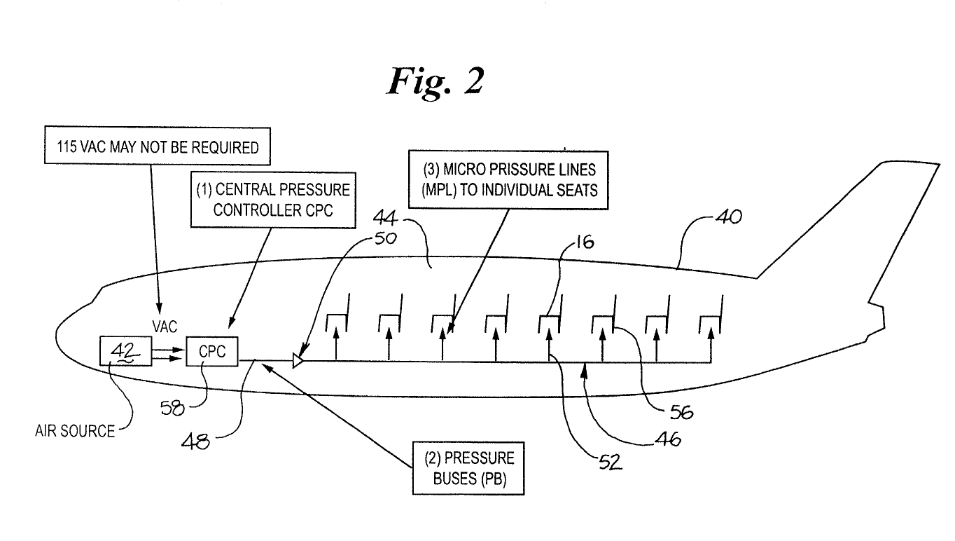

In some embodiments of the invention, the sleeve 10 may be a component of a larger system designed to provide a vehicle with the ability to pressurize one or more sleeves, thereby allowing passengers the ability to enjoy the anti-thrombosis treatment provided by the sleeve 10 while seated in the vehicle. Such a system may be provided with a centralized pressure source to which one or more sleeves may be fluidly engaged. An example of such a system as utilized on an airplane is illustrated in FIG. 2. Such a system of a centralized pressure source and sleeves are not limited to applications involving vehicles. For example the central air system of a hospital could be adapted to supply the necessary pneumatic pressure to one or more sleeves 10.

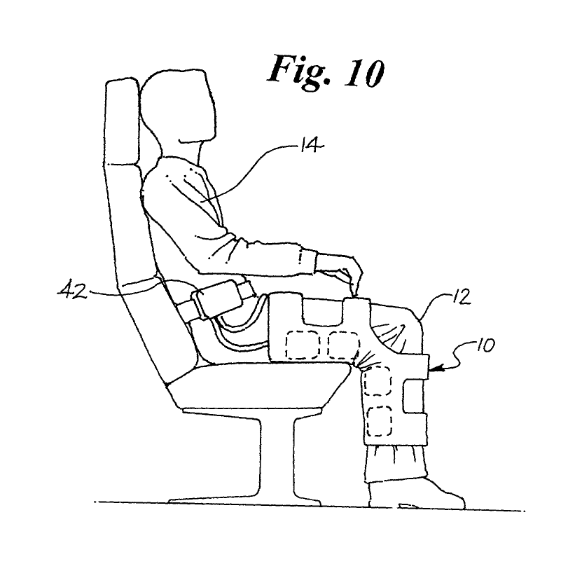

In various embodiments, the sleeve 10 may be constructed from light weight plastic, rubber or other material that is easily collapsed. When utilized with a system on a vehicle, the entire sleeve 10 may be folded up and stored in the magazine compartment of a seat 16 or in some other easily accessible compartment for re-use. The sleeve 10 may be employed by anyone who remains seated or is restricted in movement. In the embodiments described below, the sleeve 10 is described as it may be employed on an airplane. However, it should be understood, that the sleeve 10 may be utilized on any type of vehicle in addition to airplanes, such as busses, trains and even automobiles, among others. Any type of vehicle could be supplied with the required pressure source described below to provide operative pressure to the sleeve 10. It should be further understood that in some embodiments the sleeve 10 may be utilized on an individual basis with a portable pressure source 42 as is shown in FIG. 10. In the embodiment shown in FIG. 10, the air source 42 is shown as a belt worn device. Such an air source 42 could be an electrically powered, such as by battery, air compressor, or alternatively may be a simple container of compressed air and a air flow regulator. Other types of portable air sources that may be known may also be alternatively utilized.

Whether the sleeve 10 is a portable unit or otherwise, the sleeve 10 may be constructed from plastic or any other type of flexible material capable of enclosing a fluid to a predetermined pressure. The sleeve 10 may be disposable or it may be more constructed of higher grade material to be made more rugged for repeated use.

As may be seen in FIG. 2, in at least one embodiment of the invention an airplane 40 may be equipped with a pneumatic pressure source 42 which provides a predetermined flow of pneumatic fluid, such as air, to be distributed throughout the passenger cabin 44 via a system of pneumatic conduits or leads 46.

The air source 42 may be any type of pressure source which may be located on an airplane 40 or other vehicle such as a bus, train, boat or car. The pressure source 42 may be air redirected from the planes engine or may be compressed air supplied by an air compressor. If the air source requires electricity to operate, it must be configured to be run off of the electrical system of an aircraft and meet the appropriate regulations and guidelines set forth for aircraft components. The air source 42 may be an air compressor, a bellows system, or some other type of pneumatic pressure distributor.

A system of leads 46 provides fluid communication between the air pressure source 42 and one or more individual passenger positions or seats 16. The system of leads 46 may be comprised of different sized leads. In the embodiment shown in FIG. 2, leading directly from the pressure source 42 is one or more primary pressure busses 48. Theses primary buses may be hollow tubes of a diameter sufficient to transport pneumatic fluid, preferably air, indicated by arrow 50, throughout the lead system 46 of aircraft 40. Leading off of the primary buses 48, are a plurality of smaller pressure busses or leads 52. These smaller pressure busses 52 run from the primary buses 48 to the individual passenger positions or seats 16, where individual sleeves 10 (shown in FIG. 1) may be connected to the system 46.

Each of the smaller buses 52 end in a connection port 56 which may be positioned on or around the seat 16 to provide the passenger 14, such as depicted in FIG. 1, to access the port 56 with a variety of devices such as the sleeve 10. In the embodiment shown in FIG. 2, the lead system 46 is sized to support the total flow rate of all the downstream seat loads. The number of primary leads 48 as well as the number of smaller leads 52 may vary depend on the size of the aircraft 40, the number of passengers seats 16, and the possible pressure output of the pressure source 42.

In one embodiment of the invention, the pneumatic pressure source 42 may also be equipped with a centralized pressure controller 58 which may be configured to interrupt the air flow traveling from the pneumatic pressure source 42 to the lead system 46. The controller 58 may be configured to interrupt the flow of air from the pressure source 42, to the sleeves 10, such as shown in FIG. 1, with a predetermined inflation and deflation cycle, thereby allowing a single controller 58 to provide a desired cycle of inflation and deflation to any and all sleeves 10 which are plugged into the ports 56.

The controller 58 may be embodied in a wide variety of forms. For example the controller 58 may an electric regulator which merely acts as a “circuit breaker” to intermittently cease the flow of pneumatic fluid 50 from the source 42. However, in such a basic embodiment, the individual sleeves would include a pressure/release valve or other regulator device for releasing pressure from within each sleeve.

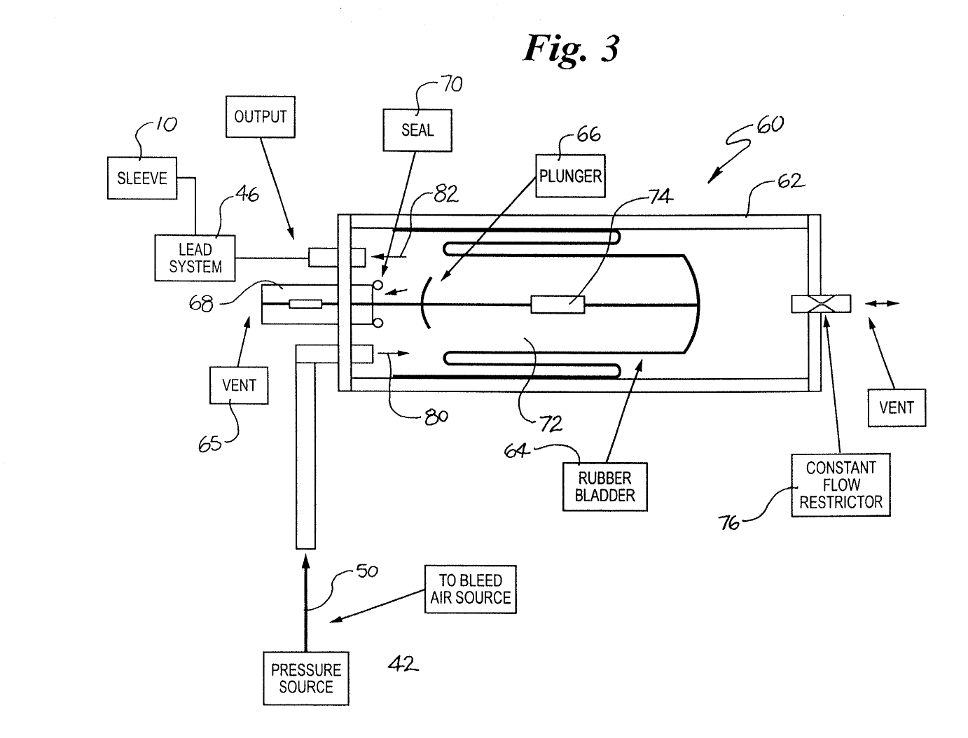

In at least one embodiment of the invention the controller 58 may be a be a pneumatic oscillator, such as may be seen in FIG. 3 and indicated generally at 60, which regulates the constant flow of fluid pressure 50 supplied by the pressure source 42 and produces a time varying output pressure which is used to cycle the pressure of the sleeve 10 automatically without intervention, except to adjust the rate of pressure cycling as desired.

As is also shown in FIG. 3 the oscillator 60 has a housing 62 which contains a flexible bladder 64, and a vent 65. The bladder 64 is operatively engaged to a plunger 66 which is actuated by the flow of fluid 50 into the housing 62. In the at rest state the first spring 68 exerts a sufficient biasing force to retain the plunger 66 against the seal 70 to close the vent 65. In operation, the fluid 50 enters the housing 62 from the pressure source 42. Because the vent 65 is held closed by the plunger 66, the fluid 50 is transmitted into the lead system 46 and eventually to any sleeves 10 connected thereto. When the sleeves 10 have been inflated to a predetermined pressure an output pressure 82 will build within the bladder 64 and cause the bladder 64 to expand into the remaining portion of the housing 62. As the pressure on the plunger side 72 of the bladder 64 increases, the output pressure 82 will rise to equal the bleed air input pressure 80 and remain there until the bladder 64 begins to expand.

As the bladder 64 expands a second spring 74 is provided with sufficient force to overcome the biasing force of the first spring 68. In addition, bladder expansion is restrained by the constant flow valve 76. The constant flow valve 76 may be a small hole or an opening in the housing 62 to allow for venting. Alternatively, the flow valve 76 could take the form of an adjustable needle valve to allow adjustment of the period of the oscillation, if desired.

Eventually, the bladder 64 expands far enough so that the second spring 74 exerts enough force to overcome the force of the first spring 68 plus some additional force necessary to overcome the bleed air pressure 80 against the plunger 66. As the seal breaks and the fluid is no longer directed into the lead system 46, but is also free to exit the housing through the vent 65. As a result the output pressure 82 drops to the ambient value, and the sleeves 10 are able to deflate. At this point, the plunger side 72 of the bladder is now at ambient pressure so the first spring 68 pulls the plunger 66 back toward the seal 70 at a rate limited by the constant flow valve 76. This flow rate limitation may vary the time required before the plunger 66 will again close and the cycle can repeat. Eventually the plunger 66 moves back to the seal 70 and seals the vent 65 and then the inflation process is repeated.

Returning to the embodiment of the invention shown in FIG. 1, each chamber 18 of the sleeve 10 are to be inflated and pressurized in a specific sequence so as to inflate the chamber 18 disposed about a passenger's ankle 20 and then inflate the remaining individual chambers 18a-f progressively moving up the leg 12 until all of the chambers 18a-f are inflated.

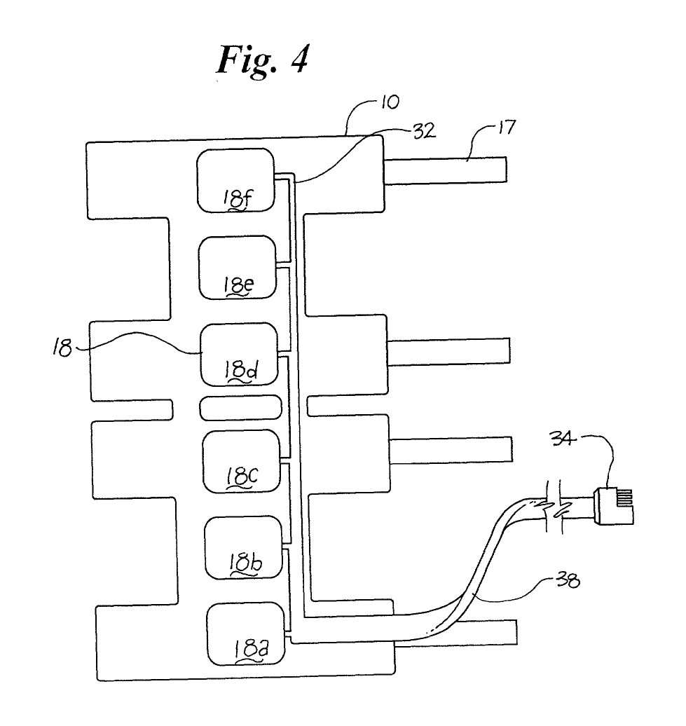

In FIG. 4, an embodiment of the sleeve 10 may be seen in the open or unworn configuration. The sleeve 10 has a body portion 30 which contains six chambers 18a-f. It should be noted that, a sleeve 10 may be configured to have any number of a plurality of chambers 18. Each of the chambers 18 is in fluid communication with a separate inflation tube 32. Each inflation tube 32 supplies the associated chamber 18 with air to provide the associated chamber 18 with a predetermined pressure. All the chambers 18 may be inflated to a predetermined uniform dynamic pressure of about 20 mmHg to about 80 mmHG.

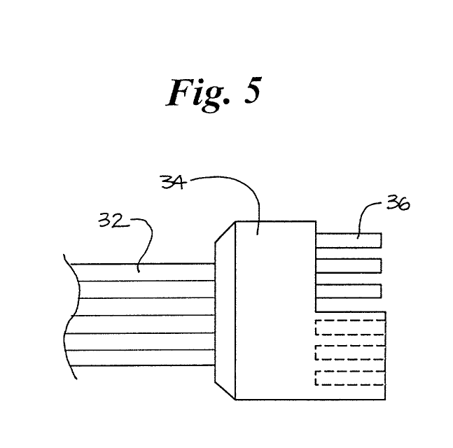

As may be seen in FIGS. 4 and 5 the inflation tubes 32 may be organized into a parallel type port or plug 34, wherein the plug 34 has a number of connection leads 36 which corresponds to the numbers of inflation tubes 32. The plug 34 may be inserted into a air outlet port 56 such as previously described. The plug 34 may be integral with the sleeve 10 or may be a inflation member 38 which is connectable to the sleeve 10 and the port 56. Where an oscillator, such as previously described, is used to regulate the inflation of the chambers starting with the lowest chamber 18a and moving up the sequence until the upper most chamber 18f is pressurized last, an individual oscillator 60 would be required for control of each chamber 18a-f. However, it should be noted that even where several sleeves are utilized in the same system a single oscillator would control a given chamber of all of the sleeves. The oscillators would be timed such that inflation of the chambers 18 a-f may occur in the sequence desired.

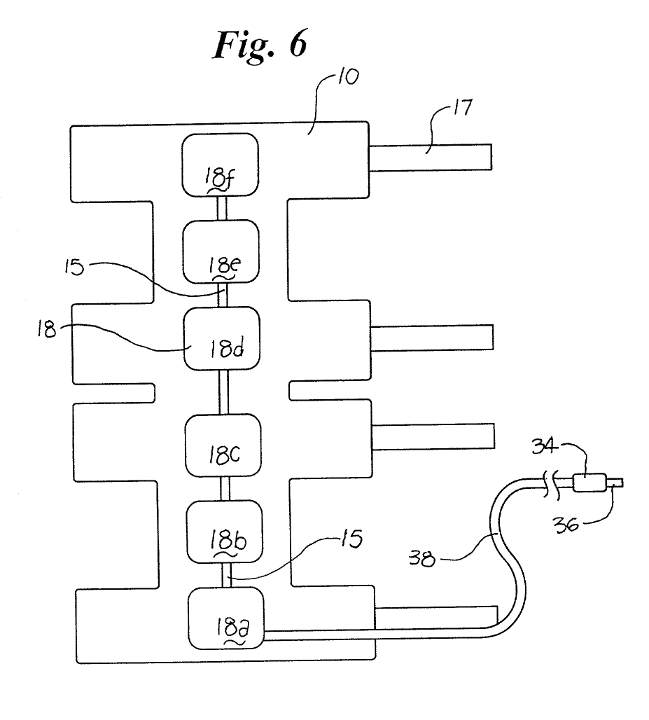

In an alternative embodiment shown in FIG. 6, the inflation member 38 may include a plug 34 which has only a single connection lead 36. In this embodiment the sleeve 10 may have chambers 18 which are inter-connected by a series of valves 15, rather than each chamber 18 being separately inflatable, such as is depicted in FIG. 4. In the present embodiment, inflation fluid, such as pressurized air, passes from the port via plug 34 into the inflation member 38, and into to the first chamber 18a of the sleeve 10. When the first chamber 18a is inflated to a predetermined pressure, the pressure valve 15 allows fluid to flow from the first chamber 18a to the second chamber 18b. The individual pressure valve assemblies 15 are constructed such that during the inflation of chambers 18, previously inflated chambers maintain the desired pressure therein. In the same manner as chambers 18a and 18b, the remaining chambers 18c-f may be sequentially inflated. In the embodiment shown in FIG. 6 a single oscillator or controller may be used to inflate all of the chambers of all of the sleeves connected to the system. The valves 15 may be configured to control deflation of the chambers 18 as well.

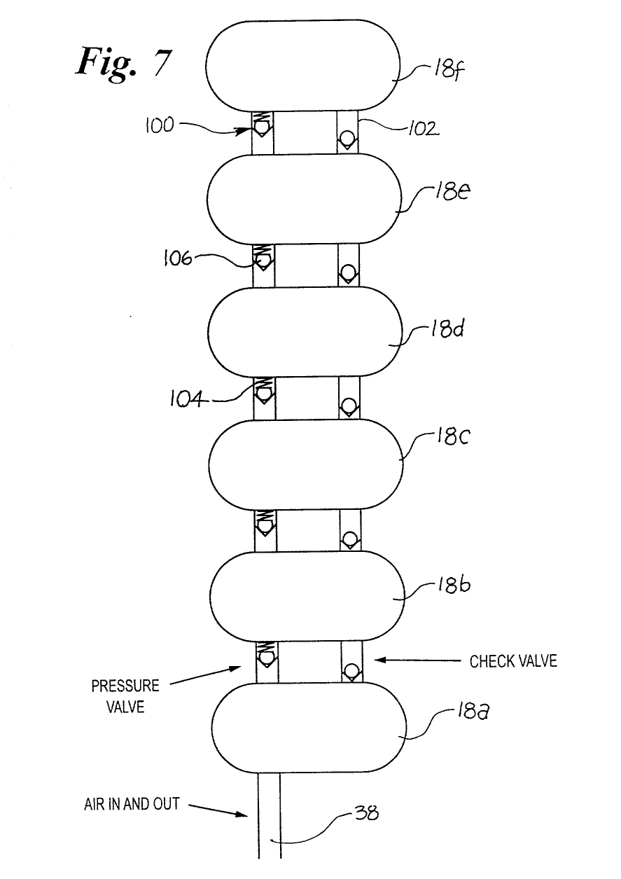

In another embodiment of the invention shown in FIG. 7, the chambers may be connected by a series of pressure valves 100 and check valves 102. Each pressure valve 100 comprises a spring 104 and ball 106. The spring 104 provides a predetermined biasing force on the ball 106 such that the ball seals the valve 100 until a predetermined pressure is reached which overcomes the biasing force of the spring 104 thereby releasing the seal previously provided by the biased ball 106. In practice, as air enters the first chamber 18a via inflation member 38, the chamber 18a will reach a predetermined pressure value. Once chamber 18a reaches the predetermined pressure value the pressure valve 100 between chamber 18a and 18b will be subjected to a sufficient air pressure to overcome the biasing force of spring 104 thereby breaking the seal of ball 106 and allowing air to begin flowing into chamber 18b. As long as air continues to flow into the sleeve 10 via member 38, air will cascadingly flow into the remaining chambers 18c-f. As valves 100 systematically fail to allow air to flow into adjacent chambers 18a-f, the check valves 102 keep the air pressure of previously filled chambers substantially equal during inflation.

Once all of the chambers 18a-f are filled to the desired predetermined air pressure, air flow via member 38 is stopped. Preferably, air flow is in fact reversed by applying a vacuum, via member 38 to the sleeve 10. Through application of a vacuum force or negative air flow, the valves 100 and/or 102 will be in an unsealed state thereby allowing all of the chambers 18a-f to be deflated. Once the chambers 18a-f are deflated to a predetermined extent, fully or otherwise, the air flow may then again be reversed to allow air pressure to being systematically filling the chambers 18a-f again.

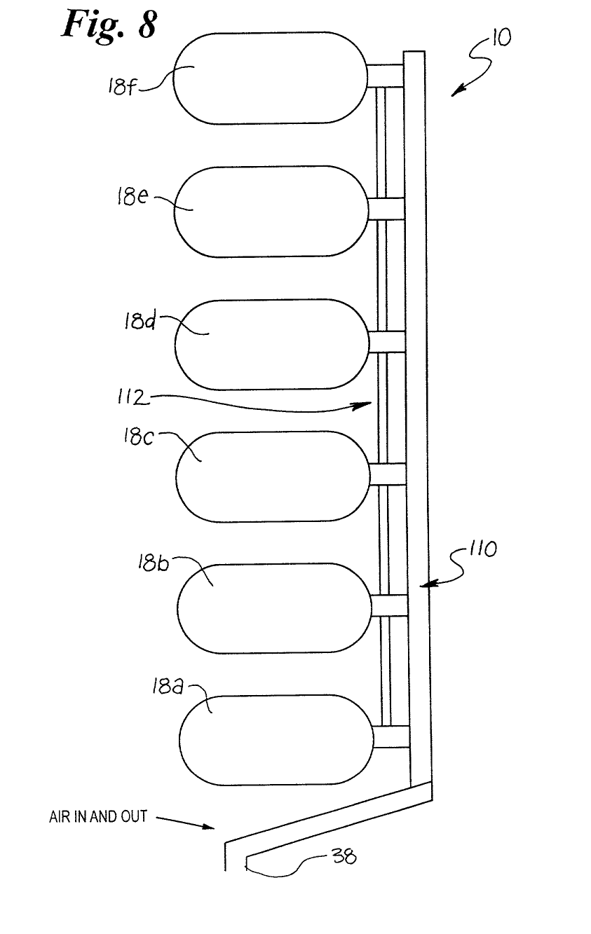

In an alternative embodiment of the invention shown in FIG. 8, the sleeve 10 includes a single piece check valve 110 in fluid communication with each chamber 18a-f. In the embodiment shown, when air is flowing into the sleeve 10 through member 38, air is allowed to freely flow into the first chamber 18a. However, the check valve 110 prevents the air from back flowing into member 38. Instead, once chamber 18a reaches a predetermined pressure, air is directed to the next chamber 18b, through flow tube 112. Subsequent chambers 18c-f are subsequently filled one at a time in the same manner via flow tube 112. When all the chambers 18a-f are filled to a predetermined pressure, the check valve 110 will allow air flow from the chambers 18a-f into member 38. Preferably, when all the chambers 18a-f are filled, a vacuum is applied via member 38 which causes check valve 110 to release the pressure contained in the individual chambers 18a-f.

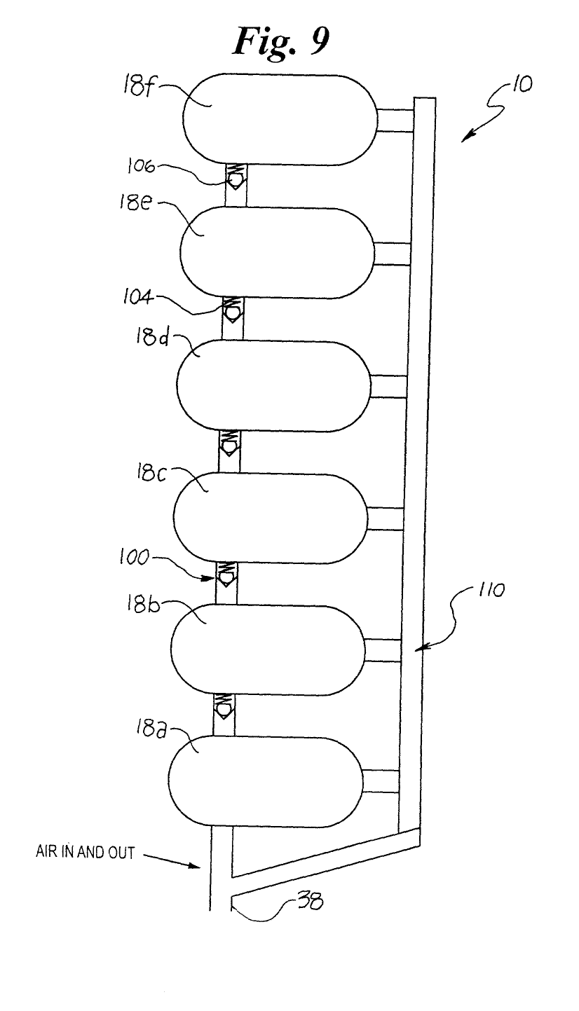

In yet another embodiment shown in FIG. 9, the sleeve 10 has a valve and chamber configuration which includes both a single check valve 110 and a series of pressure valves 100 such as have been previously described. In the embodiment shown in FIG. 9, the chambers 18a-f are inflated one after the other as air pressure in preceding chambers is sufficient to overcome the biasing force of springs 104 thereby releasing the seal provided by balls 106. When all the chambers 18a-f are filled to a predetermined pressure, or a vacuum is applied to the sleeve 10 via member 38, the check valve 100 simultaneously releases the pressure contained in the chambers 18a-f in order to return the chambers 18a-f to the uninflated state.

As may be seen in FIGS. 4 and 6, the sleeve 10 may include a plurality of adjustment straps 17. The adjustment straps may be connected to one another when the sleeve 10 is disposed about the leg(s) 12 of a passenger 14, such as shown in FIG. 1. The straps may have any type of fasteners such as buckles, hook and loop material such as VELCRO, buttons, clips, etc. The straps 17 are adjustable so that the sleeve 10 may be placed around a wide range of leg sizes.

In the embodiment shown in FIG. 1, and in all embodiments disclosed herein, the sleeve 10 must be connected to the pressure outlet port 56. The sleeve 10 and/or inflation member 38 may include a variety of plug 34 types which may be removably engaged to the port 56. In an alternative embodiment of the invention, the sleeve 10 may be in operatively engaged to the seat belt of the seat 16. Such that when the passenger 14 places the sleeve 10 about his or her leg(s), the act of fastening the seat belt connects the plug 34 to the port 56, thereby activating the inflatable sleeve 10. If desired, the sleeve 10 may be integral with the seat 16, thus forcing the passenger to utilize the sleeve 10 when the seat belt is fastened.

In addition to being directed to the specific combinations of features claimed below, the invention is also directed to embodiments having other combinations of the dependent features claimed below and other combinations of the features described above.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

1. A system comprising in combination:
a vehicle having a pneumatic pressure source for supplying a predetermined flow of pneumatic fluid to a plurality of passenger positions, the pneumatic pressure source having a plurality of leads, each of the plurality of leads extending to a connection port, the plurality of leads being distributed throughout the vehicle such that each of the plurality of passenger positions is equipped with at least one connection port; and
at least one inflatable compression sleeve having a plurality of inflatable chambers therein, the at least one sleeve constructed and arranged to be engaged to the at least one connection port, thereby providing fluid communication between the pneumatic pressure source and the plurality of chambers.

2. The system of claim 1 further comprising at least one pneumatic controller, the at least one pneumatic controller being in fluid communication with the pneumatic pressure source and the plurality of leads, the at least one pneumatic controller constructed and arranged to periodically interrupt the flow of pneumatic fluid from the pneumatic pressure source to the plurality of leads.

3. The system of claim 2 wherein the at least one pneumatic controller further comprises a plurality of pneumatic controllers, each of the pneumatic controllers constructed and arranged to be operatively engaged to one of the inflatable chambers of the at least one sleeve.

4. The system of claim 1 wherein the plurality of chambers are constructed and arranged to be inflated according to a predetermined sequence.

5. The system of claim 4 wherein the plurality of chambers are constructed and arranged to be deflated according to a predetermined sequence.

6. The system of claim 1 wherein the predetermined flow of pneumatic fluid provides each of the plurality of chambers with a predetermined inflation pressure of about 20 mmHg to about 150 mmHg.

7. The system of claim 1 further comprising an inflation member and the at least one sleeve having an inflation member engagement port, each of the plurality of chambers being in fluid communication with the inflation member engagement port, the inflation member having a first end and a second end, the first end being in fluid communication with the second end, the first end adapted to be engaged to the connection port, the second end adapted to be engaged to the inflation member engagement port.

8. The system of claim 5 wherein the at least one sleeve further comprises a control valve, the control valve constructed and arranged to release the predetermined pressure from the plurality of chambers.

9. The system of claim 1 wherein the at least one sleeve is adapted to be disposed about at least one leg of a passenger.

10. The system of claim 6 wherein the at least one sleeve further comprises a plurality of securement straps.

11. The system of claim 8 wherein the plurality of securement straps are adjustable.

12. The system of claim 1 wherein the pneumatic fluid is air.

13. The system of claim 1 wherein the at least one sleeve comprises a plurality of sleeves, each of the plurality of sleeves constructed and arranged to be engaged to the at least one connection ports, thereby providing fluid communication between the plurality of chambers and the pneumatic pressure source.

14. The system of claim 1 wherein the at least one sleeve is constructed from plastic.

15. The system of claim 1 wherein the at least one sleeve is disposable.

16. The system of claim 1 wherein the plurality of chambers are in fluid communication with one another.

17. The system of claim 1 wherein the at least one sleeve is integral with at least a portion of each of the plurality of passenger positions.

18. An anti-thrombosis device comprising:
a sleeve constructed and arranged to be removably disposed about an appendage, the sleeve having a plurality of inflatable chambers constructed and arranged to be inflated from an uninflated state to an inflated state when in fluid communication with a positive pressure source, the plurality of inflatable chambers comprising a first inflatable chamber and a second inflatable chamber, the first inflatable chamber in fluid communication with the second inflation chamber, when the first inflatable chamber is in fluid communication with the positive pressure source the first inflatable chamber being inflated to the inflated state, the second inflatable chamber being inflated to the inflated state subsequent to inflation of the first inflatable chamber.

19. The anti-thrombosis device of claim 18 wherein the plurality of inflatable chambers further comprises a third inflatable chamber, the third inflatable chamber being inflated to the inflated state subsequent to inflation of the second inflatable chamber.

20. The anti-thrombosis device of claim 19 wherein the plurality of inflatable chambers further comprises a fourth inflatable chamber, the fourth inflatable chamber being inflated to the inflated state subsequent to inflation of the third inflatable chamber.

21. The anti-thrombosis device of claim 20 wherein the plurality of inflatable chambers further comprises a fifth inflatable chamber, the fifth inflatable chamber being inflated to the inflated state subsequent to inflation of the fourth inflatable chamber.

22. The anti-thrombosis device of claim 21 wherein the plurality of inflatable chambers further comprises a sixth inflatable chamber, the sixth inflatable chamber being inflated to the inflated state subsequent to inflation of the fifth inflatable chamber.

23. The anti-thrombosis device of claim 18 wherein the positive pressure source is portable.

24. The anti-thrombosis device of claim 18 wherein the positive pressure source is a pneumatic pressure source of a vehicle.

25. The anti-thrombosis device of claim 24 wherein the vehicle is an airplane.

26. The anti-thrombosis device of claim 18 wherein each of the plurality of inflatable chambers are separated by at least one pressure valve.

27. The anti-thrombosis device of claim 18 wherein each of the plurality of inflatable chambers are separated by at least one check valve.

28. The anti-thrombosis device of claim 26 wherein each of the at least one pressure valves are comprised of a biasing member and a ball, the biasing member biasing the ball in a first position with in the at least one pressure valve, the ball being placed in a second position when the inflatable chamber adjacent thereto is in the inflated state.
